(19) United States
(12) Patent Application Publication
(10) Pub. No.: US 2016/0148734 A1
(43) Pub. Date: May 26, 2016

(54) MAGNETIC MATERIAL, USE THEREOF, AND METHOD FOR PRODUCING SAME

(71) Applicant: Robert Bosch GmbH, Stuttgart (DE)

(72) Inventors: Roman Karimi, Aalen (DE); Roland Stein, Aalen (DE); Lars Bommer, Leonberg (DE); Friederike Koeppen, Asperg (DE); Dagmar Goll, Plüderhausen (DE); Juergen Oberle, Sindelfingen (DE); Arne Huber, Boeblingen (DE); Gerhard Schneider, Ebersbach (DE); Ralf Loeffler, Fellbach (DE)

(21) Appl. No.: 14/898,478

(22) PCT Filed: Jun. 10, 2014
(86) PCT No.: PCT/EP2014/062001

§ 371 Date: Dec. 14, 2015

(30) Foreign Application Priority Data
Jun. 13, 2013 (DE) 102013009940.4

(51) Int. Cl. H01F 7/02; C22C 38/10; C22C 38/00; C22C 38/14; H01F 1/053; H01F 41/02

(52) U.S. Cl. CPC H01F 7/0278; H01F 1/0536; H01F 41/0293; C22C 38/005; C22C 38/14; C22C 38/10

(57) ABSTRACT

The invention relates to a magnetic material which contains at least one transition metal (TM), at least one rare earth metal (RE), and titanium. The content of the transition metal equals 74 to 94 at %, the content of the rare earth metal equals 2 to 20 at %, and the content of titanium equals 7 to 9 at %, in each case based on the total mass of the magnetic material, and the transition metal comprises cobalt.

### BACKGROUND OF THE INVENTION

The present invention relates to a magnetic material, the use thereof and also a process for producing the magnetic material.

Due to the increased use of electric motors, not least in motor vehicle construction, in recent times, the demand for high-performance magnetic materials, especially in permanent magnets, has increased greatly in recent years. Suitable magnetic materials comprise those which have hard-magnetic phases and display a high remanent magnetization, a high coercive field and a large energy product. Due to the high power density of these magnetic materials, they are particularly well suited for use in apparatuses which have a small installation space. High-performance, durably stable and cost-extensive magnetic materials are therefore key components of electromobility. Magnetic materials which comprise at least one rare earth metal such as neodymium (Nd), praseodymium (Pr) and samarium (Sm) and also at least one transition metal such as iron (Fe) or cobalt (Co) have been found to have particularly high performance, i.e. a large energy product. Such materials are often admixed with interstitial additives, for example boron (B), carbon (C), nitrogen (N) or hydrogen (H), in order to optimize the microstructure and thus also the intrinsic magnetic properties. Nd₂Fe₁₄B has been found to be a particularly high-performance magnetic material. However, owing to its limited chemical, mechanical and thermal long-term stability, complete replacement of the conventional ferrites by Nd₂Fe₁₄B has not yet taken place. A further disadvantage of Nd₂Fe₁₄B are its high raw materials and production costs. In addition, the availability of rare earth metals in like quantities is greatly limited, as a result of which the production volume of magnets based on magnetic materials having a high rare earth metal content, for example Nd₂Fe₁₄B, are greatly limited.

### SUMMARY OF THE INVENTION

The magnetic material of the invention displays excellent magnetic properties and thus a high remanent magnetization, a high coercive field strength and a large energy product. Its mechanical, magnetic and thermal stability is high, which predestines it for use in highly demanding, for example mobile, apparatuses such as motor vehicles and mobile electronic appliances. The use of at least one transition metal (TM), at least one rare earth metal (RE) and titanium, where the content of transition metal is from 74 to 94 atom %, the content of rare earth metal (RE) is from 2 to 20 atom % and the content of titanium is from 3 to 15 atom %, in each case based on the total mass of the magnetic material, and the transition metal comprises cobalt, gives a high efficient magnetic material which displays particularly good mechanical properties and especially excellent magnetic properties. The specific content of titanium firstly stabilizes the lattice microstructure of the magnetic material and secondly promotes formation of anisotropy. It has also been found that cobalt, especially in the abovementioned combination with titanium, makes a significant contribution to improving the magnetic properties of the magnetic material of the invention. In particular, combination of a transition metal, a rare earth metal and titanium with cobalt increases the anisotropy constant and saturation polarization. This means that both the strength of the magnetic material and also its demagnetization resistance, i.e. its coercive field strength, and thus the power density of the magnetic material are improved by the element combination according to the invention. Furthermore, the content of rare earth metal can be effectively reduced in this way, which lowers the raw materials cost for the magnetic material of the invention and ensures high availability of the raw materials. In this way, supply bottlenecks can be prevented and limitation of the production volumes can be circumvented. In addition, the addition of cobalt significantly increases the Curie temperature of the magnetic material, which is beneficial to the use of the magnetic material particularly where very high temperatures occur, for example in electric motors and generators. The use of the magnetic material of the invention consequently opens up a variety of possible uses, also in low-price products, without having an adverse effect on the qualitative properties thereof.

In an advantageous embodiment of the invention, the transition metal comprises cobalt in a proportion of from 1 atom % to less than 50 atom %, preferably from 3 to 30 atom % and in particular from 8 to 20 atom %, based on the total content in atom % of transition metal. An optimal compromise between very good magnetic properties and a moderate cost structure of the magnetic material is achieved in this way.

More advantageously, the transition metal contains at least one of: iron (Fe), nickel (Ni) and manganese (Mn) or mixtures thereof, with the major part preferably being iron. The transition metals mentioned here form particularly stable lattice structures with rare earth metals, titanium and cobalt and contribute to an increased extent to establishment of the desired advantageous magnetic properties, i.e. in particular to saturation and an increase in the magnetic anisotropy of the material of the invention. Furthermore, their availability on the market as relatively low materials costs is high, which significantly reduces the materials costs of the magnetic material of the invention. The preferred use of Fe from among these metals can be attributed to its lack of problems in respect of health and the environment and also to its significantly reduced raw materials costs compared to Ni and Mn.

In a further advantageous embodiment, the rare earth metal is selected from the group consisting of: neodymium (Nd), lanthanum (La), cerium (Ce), dysprosium (Dy), praseodymium (Pr), samarium (Sm), promethium (Pm), yttrium (Y), scandium (Sc), gadolinium (Gd), holmium (Ho) and erbium (Er), and is preferably Ce and/or La. The rare earth metals Nd, La, Ce, Dy, Pr, Sm, Pm, Y, Sc, Gd, Ho and Er listed have been found to have particularly good compatibility with the other components according to the invention and on their part promote the formation of crystal lattice structures which are stable in the long term and have high anisotropy, as a result of which the magnetic properties of the magnetic material of the invention are improved. Owing to the particularly good availability and relatively low materials costs, the use of the elements La and Ce is particularly advantageous.

More advantageously, the content of transition metal is from 79 to 89 atom %, preferably from 82 to 86 atom %, and/or the content of rare earth metal is from 5 to 11 atom %, preferably from 7 to 9 atom %, and/or the content of titanium is from 5 to 11 atom %, preferably from 7 to 9 atom %, in each case based on the total mass of the magnetic material. The power density and the mechanical properties of the magnetic material of the invention are improved in this way. In particular, the remanent magnetization and the coercive field strength of the magnetic material of the invention are maximized in this way at a reduced content of rare earth metal and thus optimized cost structure.

In a further advantageous embodiment, the structure of the magnetic material of the invention is tetragonal RE(TM,Ti)₁₂, which, owing to the advantageous electron structure and electron configuration and also the spin and orbital moments of the atoms, has a positive effect on the formation of anisotropic phases of the magnetic material of the invention.

Furthermore, the invention also describes a permanent magnet which comprises a magnetic material as described above. The material of the invention is preferably present as hard-magnetic phase in the permanent magnet of the invention. The permanent magnet of the invention can have further magnetic or nonmagnetic phases in addition to the magnetic material of the invention but can also consist entirely of the magnetic material of the invention. The permanent magnet can, for example, be sintered or polymer-bonded in a conventional way.

The advantageous effects, advantages and embodiments described for the magnetic material of the invention also apply to the permanent magnets of the invention.

The invention likewise describes a process for producing a magnetic material, wherein the process is characterized by the steps of mixing of at least one transition metal (TM), at least one rare earth metal (RE) and titanium, where the content of transition metal is from 74 to 94 atom %, the content of rare earth metal is from 2 to 20 atom % and the content of titanium is from 3 to 15 atom %, in each case based on the total mass of the magnetic material, and the transition metal comprises cobalt, and melting of the mixture obtained. The process of the invention provides, in a simple and inexpensive manner, a magnetic material having a high power density, excellent remanent magnetization and coercive field strength and also a large energy product, which also has very good mechanical stability.

The melting of the mixture of the elements according to the invention can be carried out, for example, in an electric arc or in a vacuum furnace. This way of carrying out the process ensures that all elements are completely melted without oxidation of the material occurring, so that a homogeneous crystal microstructure which not only has an advantageous effect on the mechanical stability of the magnetic material being formed but also promotes the desired magnetic properties to a considerable degree is formed.

The advantageous properties, effects and embodiments described for the magnetic material of the invention also apply to the process of the invention for producing such a magnetic material. Furthermore, it may be said that the above-described magnetic material can be produced by the process of the invention.

In a further advantageous embodiment, a heat treatment at a temperature in the range from 500° C. to 1500° C., preferably from 700° C. to 1100° C., for a time of from 10 minutes to two weeks and preferably from 5 to 12 days is carried out in a step following melting. This heat treatment, which is preferably carried out under a protective gas atmosphere and in particular under argon, promotes complete formation of the magnetic material, preferably as hard-magnetic phase.

In a further advantageous embodiment of the process of the invention, the mixture obtained after melting or after heat treatment has been carried out is milled and/or subjected to nitriding in a subsequent step. The milling of the mixture obtained assists its further processability, for example to form a sintered magnetic material. Nitriding can improve the magnetic properties of the material, in particular its anisotropy. The mixture obtained is particularly advantageously firstly milled and subsequently nitrided since this makes it possible to achieve uniform nitriding even into the finest particles, as a result of which the magnetic properties of the resulting material are improved to a particularly great extent.

The present invention also provides a polymer-bonded magnet which contains a magnetic material as described above or a magnetic material produced by the above-described process. The magnetic material can also have been produced by means of rapid solidification (melt spinning).

Furthermore, the invention also describes the use of a magnetic material as described above, preferably in wind power plants, passenger cars, commercial vehicles, starters, electric motors, loudspeakers and microelectromechanical systems. Owing to the excellent magnetic properties of the magnetic material of the invention and also its outstanding stability and thus also its advantageous ability to be used in applications in which installation space is restricted and applications at high temperatures, the use in the devices mentioned is particularly advantageous.

Furthermore, the invention describes an electric machine, in particular a generator, motor vehicle, starter, electric motor, loudspeaker or microelectromechanical system, which contains the magnetic material of the invention or at least one permanent magnet according to the invention or a magnetic material which has been produced by the above process of the invention. The electric machine displays very good magnetic properties and a high thermal stability at a moderate cost structure.

The advantages, advantageous effects and preferred embodiments described for the magnetic material of the invention and the process of the invention also apply to the polymer-bonded magnet and also the electric machine of the invention.

### BRIEF DESCRIPTION OF THE DRAWINGS

Embodiments of the invention are described in detail below with reference to the accompanying drawings. The drawing shows:

FIG. 1 an optical micrograph of a polished section of the magnetic material according to an advantageous embodiment in polarized light,

FIG. 2 an optical micrograph of a polished section of a cerium-, iron- and titanium-containing magnetic material in polarized light,

FIG. 3 a graph in which the saturation polarization Jₛ of the magnetic material from FIGS. 1 and 2 is shown at various temperatures,

FIG. 4 a graph which depicts a first example of a heat treatment according to an advantageous embodiment of the invention,

FIG. 5 a graph in which the saturation polarization Js of a magnetic material according to a first advantageous embodiment of the invention is plotted against the proportion of cobalt and

FIG. 6 a graph in which the Curie temperature Tc of a magnetic material according to a first advantageous embodiment of the invention is plotted against the proportion of cobalt.

### DETAILED DESCRIPTION

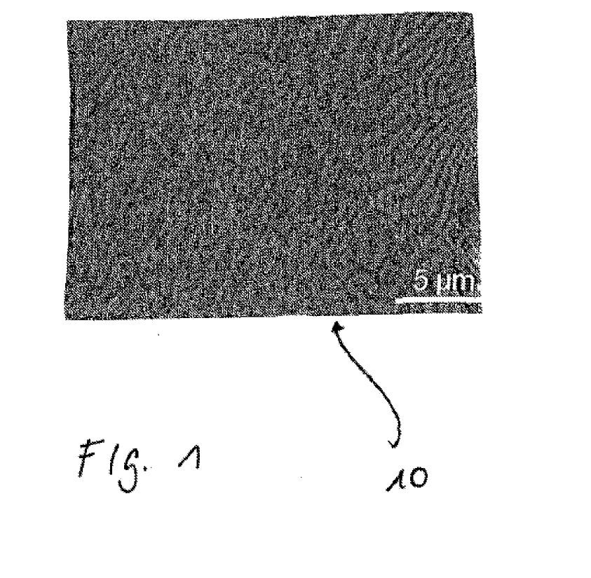

FIG. 1 shows an optical micrograph of a polished section of the magnetic material 10 according to the invention as per an advantageous embodiment in polarized light. The material 10 according to the invention has the following composition: Fe₆₄Co_{2.6}Ce_{8.0}Ti_{8.0} and is preferably present with a predominantly tetragonal Ce(Fe/Co,Ti)₁₂ (ThMn₁₂-) structure. The composition was determined by means of EDX (energy dispersive X-ray spectroscopy) and the crystal structure was determined by means of X-ray spectroscopy.

The magnetic material 10 according to the invention was obtained by mixing and melting of the individual elements in an electric arc furnace. Heat treatment at 1050° C. for 230 hours under argon resulted in formation of a hard-magnetic phase.

The magnetic material 10 according to the invention of FIG. 1 is thus present as hard-magnetic phase which can be seen from the Kerr pattern, i.e. a rosette-like or stripy pattern, depending on the angle of view, which indicates the presence of a strong hard-magnetic phase composed of Ce(Fe/Co,Ti)₁₂. The closing domains are relatively broad, which is reflected in a high anisotropy constant K1 of about 3.0 MJ/m³. The anisotropy constant K1 can be determined as described in the literature: R. Bodenberger, A. Hubert, Phys. Stat. Sol. (a) 44, K7-K11 (1977). The magnetic material 10 according to the invention thus displays a large energy product, a high Curie temperature, a high coercive field strength, high remanent magnetization and also good mechanical properties due to the homogeneous crystal structure.

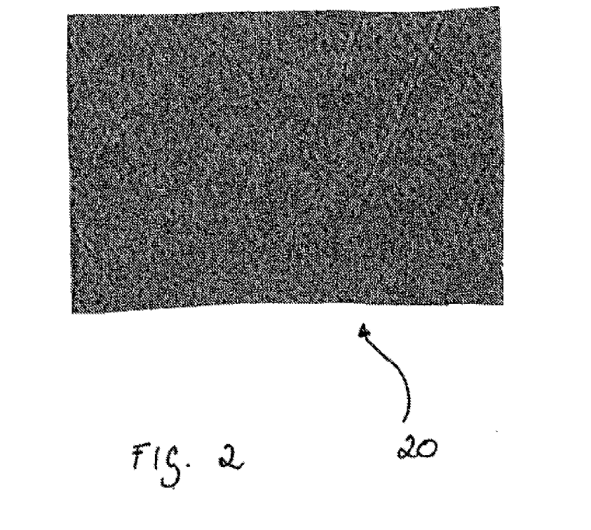

FIG. 2 shows an optical micrograph of a polished section of a cerium-, iron- and titanium-containing magnetic material 20. The magnetic material 20 has the following composition: Fe_{84.2}Ce_{8.7}Ti_{7.1} and is preferably present with a predominantly tetragonal Ce(Fe,Ti)₁₂ structure. The composition was determined by means of EDX (energy dispersive X-ray spectroscopy) and the crystal structure was determined by means of X-ray spectroscopy.

The magnetic material 20 was likewise obtained by mixing and melting of the individual elements in an electric arc furnace. Heat treatment at 1050° C. for 230 hours under argon resulted in formation of a hard-magnetic phase.

The magnetic material 20 likewise displays a Kerr pattern, but the closing domains are significantly narrower compared to the magnetic material according to the invention. This is reflected in a lower anisotropy constant of about 2.5 MJ/m³ and therefore poorer magnetic properties. In addition, the thermal stability of the magnetic material 20 is low because of the absence of cobalt.

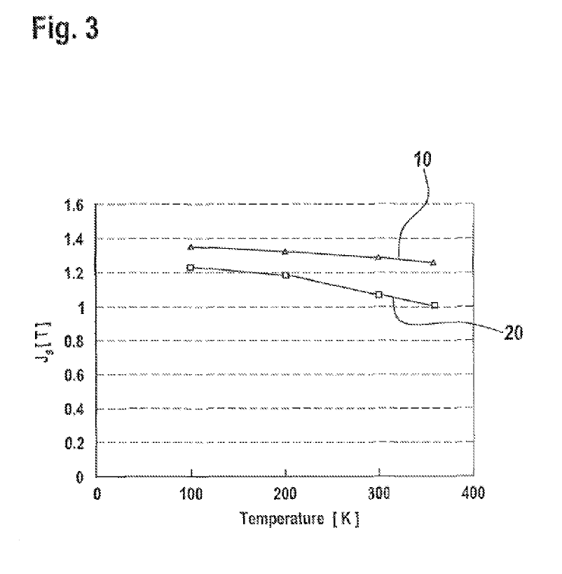

FIG. 3 is a graph in which the saturation polarization Jₛ of the magnetic materials from FIGS. 1 and 2 are shown at various temperatures. It can clearly be seen that the saturation polarization of the magnetic material 10 according to the invention is increased compared to the material 20 which is not according to the invention by the addition of cobalt, as a result of which the thermal stability is also improved. Correspondingly, the Curie temperature is also increased by the addition of cobalt, which is particularly important for applications in which high temperatures prevail, e.g. in an electric motor.

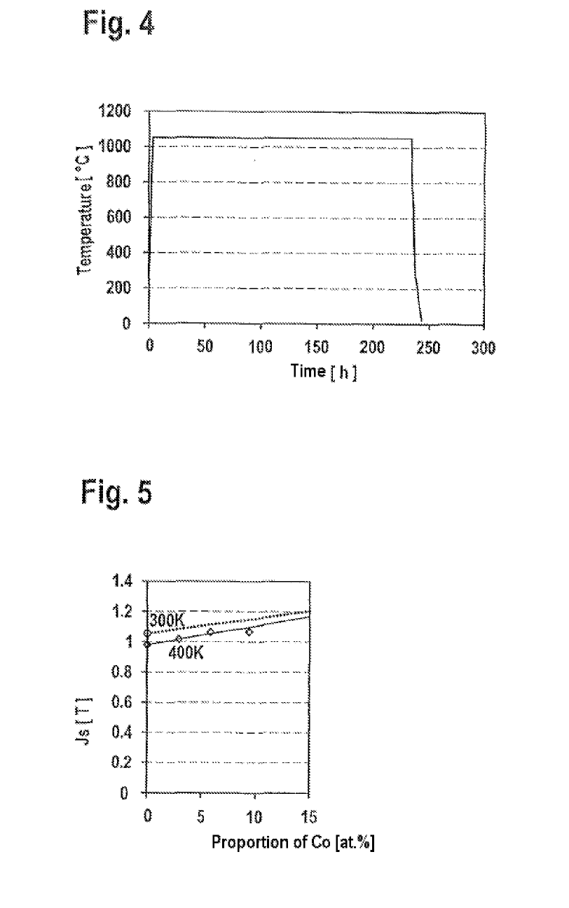

FIG. 4 shows a graph which depicts a first example of a heat treatment according to an advantageous embodiment of the invention. As indicated above, the complete formation of a hard-magnetic phase is ensured by means of a heat treatment, advantageously under protective gas, which, for example, follows the melting of the elements required according to the invention to form a magnetic material. In a first step, the molten material is for this purpose cooled and then heated over a period of about 5 hours to 1050° C. in a vacuum furnace, maintained at about 1050° C. for about 235 hours and then cooled over a period of about 5 hours to room temperature (about 20° C.). This results in formation of a magnetic material having excellent magnetic properties, i.e. a magnetic material having a fully formed hard-magnetic phase which consists, in particular, of hard-magnetic grains and also displays outstanding mechanical and thermal stability.

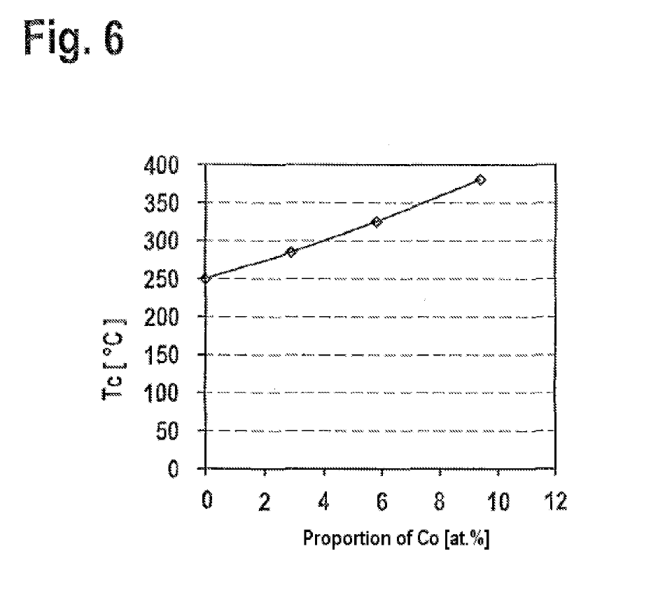

FIGS. 5 and 6 show graphs in which firstly the saturation polarization Js in tesla of the magnetic material according to the invention is plotted against the proportion of cobalt in atom percent (at. %) and secondly the Curie temperature Tc in ° C. is plotted against the proportion of cobalt in atom percent. The magnetic material had the following composition: 8 atom % of Ti, 8 atom % of Ce, Fe and Co, where Fe served as balance and the amount of Co was varied. The magnetic material was produced by mixing of the respective elements and melting of these in an electric arc.

In detail, FIG. 5 shows two curves which were recorded at different temperatures (300 K and 400 K). Both curves show that the saturation polarization Js increases with increasing proportion of cobalt. Furthermore, it can be seen that the saturation polarization no longer decreases as greatly at the higher temperature (400 K).

The curve in FIG. 6 shows that the Curie temperature Tc increases with increasing proportion of cobalt. This enables the magnetic material to be used particularly well in high-temperature applications.

1. A magnetic material containing at least one transition metal (TM), at least one rare earth metal (RE) and titanium, wherein the content of transition metal is from 74 to 94 atom %, the content of rare earth metal is from 2 to 20 atom % and the content of titanium is from 7 to 9 atom %, in each case based on the total mass of the magnetic material, and the transition metal comprises cobalt.

2. The magnetic material as claimed in claim 1, wherein the transition metal comprises cobalt in a proportion of from 1 atom % to less than 50 atom %, based on the total content in atom % of transition metal.

3. The magnetic material as claimed in claim 1, characterized in that the transition metal contains at least one of: Fe, Ni and Mn or mixtures thereof.

4. The magnetic material as claimed in claim 1, characterized in that the rare earth metal is selected from the group consisting of: Nd, La, Ce, Dy, Pr, Sm, Pm, Y, Sc, Gd, Ho, Er and mixtures thereof.

5. The magnetic material as claimed in claim 1, characterized in that the content of transition metal is from 79 to 89 atom %, and/or the content of rare earth metal is from 5 to 11 atom %, in each case based on the total mass of the magnetic material.

6. The magnetic material as claimed in claim 1, characterized in that the structure of the magnetic material is tetragonal RE(TM,Ti)₁₂ having a ThMn₁₂ structure.

7. A permanent magnet comprising at least one magnetic material as claimed in claim 1.

8. A process for producing a magnetic material, the process comprising:
mixing of at least one transition metal (TM), at least one rare earth metal (RE) and titanium, where the content of transition metal is from 74 to 94 atom %, the content of rare earth metal is from 2 to 20 atom % and the content of titanium is from 7 to 9 atom %, in each case based on the total mass of the magnetic material, and the transition metal comprises cobalt, and
melting of the mixture obtained until a homogeneous mixture is formed.

9. The process as claimed in claim 8, characterized in that a heat treatment at a temperature in the range from 500° C. to 1500° C., for a time of from 10 minutes to two weeks is carried out in a step following melting.

10. The process as claimed in claim 8, characterized in that the mixture obtained is milled and/or subjected to nitriding in a further step.

11. A polymer-bonded magnet containing
a magnetic material as claimed in claim 1.

12. (canceled)

13. An electric machine, containing a magnetic material as claimed in claim 1.

14. The magnetic material as claimed in claim 1, wherein the transition metal comprises cobalt in a proportion of from 3 to 30 atom % based on the total content in atom % of transition metal.

15. The magnetic material as claimed in claim 1, wherein the transition metal comprises cobalt in a proportion of from 8 to 20 atom % based on the total content in atom % of transition metal.

16. The magnetic material as claimed in claim 1, characterized in that the transition metal contains Fe.

17. The magnetic material as claimed in claim 1, characterized in that the rare earth metal is selected from the group consisting of: Ce and/or La.

18. The magnetic material as claimed in claim 1, characterized in that the content of transition metal is from 82 to 86 atom %, and/or the content of rare earth metal is from 7 to 9 atom %, in each case based on the total mass of the magnetic material.

19. The process as claimed in claim 8, characterized in that a heat treatment at a temperature in the range from 700° C. to 1100° C. for a time of from 5 to 12 days is carried out in a step following melting.

20. A polymer-bonded magnet containing a magnetic material produced as claimed in claim 8.

21. A polymer-bonded magnet containing a magnetic material as claimed in claim 1 which has been produced by rapid solidification.

22. An electric machine, containing at least one permanent magnet as claimed in claim 7.
